(19) United States
(12) Patent Application Publication
(10) Pub. No.: US 2018/0075702 A1
(43) Pub. Date: Mar. 15, 2018

(54) GAMES AND GAMING MACHINES WITH ACCUMULATING MULTIPLIER FUNCTIONALITY

(71) Applicant: AGS LLC, Las Vegas, NV (US)

(72) Inventors: David Bryan Wright, Las Vegas, NV (US); Christopher Brian Drake, Las Vegas, NV (US)

(21) Appl. No.: 15/263,504

(22) Filed: Sep. 13, 2016

(51) Int. Cl. G07F 17/32; G07F 17/34

(52) U.S. Cl. CPC G07F 17/3267; G07F 17/3209; G07F 17/34; G07F 17/3244; G07F 17/3213

(57) ABSTRACT

A gaming machine is configured with accumulating multiplier functionality. In one embodiment, the gaming machine presents a base game such as a slot game. In the event of one or more winning base game outcomes, the gaming machine presents a plurality of multiplier value presentation events. An accumulated value of multipliers which are selected or displayed during those presentation events defines a total multiplier value which is applied to an award associated with the winning outcome to create a total award.

### FIELD OF THE INVENTION

The present invention relates to methods of presenting and playing games and gaming machines configured to present games.

### BACKGROUND OF THE INVENTION

Many styles of gaming machines and games are known, including casual (or non-wagering) gaming and wager-based gaming. One popular style of game is the wager-based slot game. Slot games were originally presented by slot machines which utilized physical spinning reels to display a set of game symbols which defined the outcome of the game. Later, however, video slot machines were developed which display graphical representations of reels and associated slot symbols.

In order to make video slot games more exciting, various features have been added to those games. For example, various “bonus” features have been developed. These features are triggered or presented at varying times and thus break up the repetitive play of the base game. In some variations, these events offer additional awards to those offered in the base game or change or affect aspects of the base game.

As one example, a bonus feature might award a bonus award or define award values which may be received by a player at a later time. For example, in the King of Dragons™ game by Aruze, a base slot game has a Dragon Bonus feature. In one embodiment, this bonus event includes the display a plurality of orbs in a circle, each orb having a prize value. A number of the orbs are selected to reveal associated prize values. These prize values may be associated with symbols used in other parts of the game.

Another bonus feature is the “multiplier” feature. In accordance with this feature, the size of an award may be increased, such as by a multiplier value. For example, U.S. Pat. No. 5,823,874 discloses a slot game which includes an additional payout indicator, such as a rotating wheel. Awards are provided for winning base slot game outcomes. In addition, certain slot game outcomes trigger rotation of the wheel. The wheel displays multiplier values and the stopping position of the wheel results in the selection of a single multiplier value which is applied to the award for the slot game.

As another example, U.S. Pat. No. 8,647,194 discloses a game which has a base game portion and a free spin portion. In the free spin portion, a player plays one or more slot games without the requirement of a wager. To make those free spin games more exciting, a multiplier value is applied to each game and any win or award of the free spin is multiplied by the multiplier for that spin. According to this patent, the multiplier value for the free spins starts at 1X and increases by one after each free spin (e.g. for the second free spin the multiplier value is 2× and so on).

U.S. Patent Applicant Publication No. 2009/0108526 discloses a game which includes random pay table multipliers. In accordance with this invention, a pay table of winning outcomes and associated awards is modified by using a randomly assigned multiplier associated with certain pay categories.

In a variation of the game of Wheel of Fortune® by IGT called Triple Extreme! Spin, the receipt of certain triggering symbols in the base slot game trigger a Triple Extreme Bonus Spin where three wheels are displayed. Two of the wheels spin to display award values and the third wheel spins to display a multiplier value which increases the award values.

While the use of bonus features to display award values and the use of a multiplier feature relative to wagering games is known, these features have become less exciting to players. For example, in known games, a single multiplier is applied to an outcome or award and thus lends very little excitement to the anticipated outcome of the game. While the multiplier may be randomly selected so that its value is not within the player's control, the value of the multiplier may be selected or displayed to the player before the game even begins. In that situation, the player already knows the maximum potential award that may be received.

A new game and gaming machine which addresses these and other issues is desired.

### SUMMARY OF THE INVENTION

Embodiments of the invention comprise methods of playing and presenting games, and gaming machines, systems and other devices which include accumulating multiplier functionality.

One embodiment of the invention comprises a gaming machine or device which comprises a monetary funds accepting mechanism for accepting monetary funds in creating a player credit balance, at least one display device, at least one player input device, a memory device, a controller, and machine-readable code stored in the memory device and executable by the controller.

The machine-readable code is configured to cause the controller to cause the at least one display device to present a base game comprising the display of a plurality of game symbols via the at least one display device, to cause the controller to present a plurality of multiplier value presentation events via the at least one display device, each presentation event comprising the display of a selected multiplier value, wherein the selected multiplier values which are associated with the presentation events are used to define a total multiplier value, and to cause the controller to award an award to the player for a winning outcome of the base game, the award having a value comprising a base award value for the winning outcome multiplied by said total multiplier value, the award being credits to the player credit balance.

In one embodiment, the base game is a slot-type game in which a plurality of game symbols are displayed. Winning outcomes of the base game may be defined by one or more combinations of symbols along one or more pay lines, wherein the winning outcomes have associated awards.

In one embodiment, the award associated with one or more winning outcomes is multiplied by a multiplier. A triggering event, such as a particular winning outcome, may trigger the multiplier event. In such a configuration, the winning outcome award is multiplied by a total multiplier which comprises the accumulation of multiple presented or displayed individual multiplier values.

In embodiment, the multiplier value presentation events comprise spins of one or more wheels which display multiplier values. The displayed or selected multiplier value from each spin is aggregated into the total multiplier value which is applied to the winning outcome award to generate the total award.

In one embodiment, the accumulating multiplier functionality is implemented via various sets or tables of data. In one embodiment, when the game is initiated, the controller utilizes a random number generator to select a game outcome from a first table or set of data. This outcome might comprise a losing outcome, a winning outcome or a winning outcome having an associated accumulating multiplier. In the case of a losing outcome, the losing game outcome is presented. In the case of a winning outcome, the winning base game outcome is presented (without a multiplier presentation event). In the case the selected outcome if a winning outcome having an associated accumulating multiplier, the controller selects a multiplier presentation configuration from one or more second sets of data or tables. For example, if the winning outcome has an associated total or accumulated multiplier value of 8×, the controller might select form possible presentation configurations comprising 1×+3×+4×, or 1×+5×+2× from an 8× multiplier value table. The controller then presents the multiplier value presentation events corresponding to the selected configuration.

In accordance with the invention, a game is provided which has a unique and exciting multiplier feature where a winning game outcome is presented to a player and then a sequence of multiplier value presentation or selection events are presented. In this manner, a player anticipates the total multiplier value which may be applied to the winning base game outcome.

Further objects, features, and advantages of the present invention over the prior art will become apparent from the detailed description of the drawings which follows, when considered with the attached figures.

### DESCRIPTION OF THE DRAWINGS

FIG. 1 is a perspective view of one embodiment of a gaming machine in accordance with the invention;

FIG. 2 diagrammatically illustrates a configuration of the gaming machine illustrated in FIG. 1;

FIG. 3 is a flow diagram of one embodiment of a method of the invention;

FIGS. 4A-4E illustrate a sequence of game play in accordance with a game of the present invention; and

FIG. 5 illustrates a look-up table configuration for implementing functionality of the present invention via a gaming machine.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games, gaming machines and gaming systems. In a preferred embodiment, the methods of game play and presentation are implemented via a gaming machine or gaming system. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

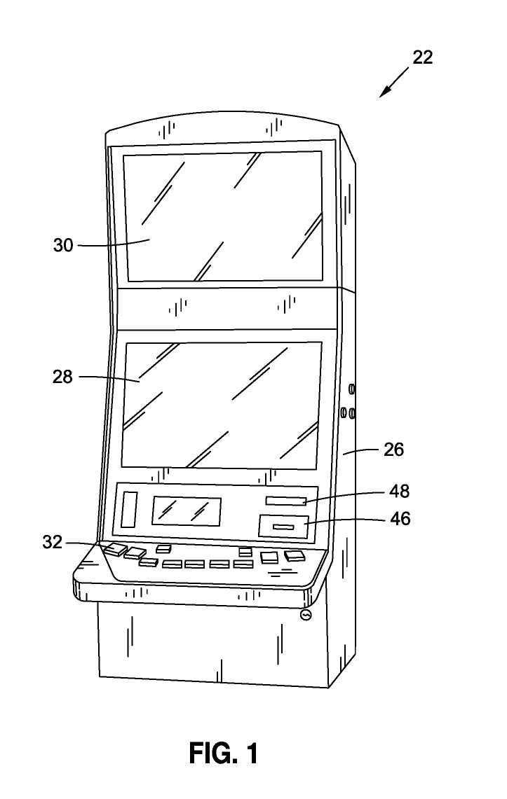

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one first display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display device 28 may be capable of projecting or displaying a wide variety of information, including images, symbols and other indicia or information associated with game play, game promotion or other events. The gaming machine 22 might include more than one display device, such as a main or first display device 28 and a secondary display device 30. The two or more display devices might be associated with the housing or, as illustrated in FIG. 1, the gaming machine 22 might also include a top box or other portion which includes the one or more second display devices 30. Also, the gaming machine 22 might include side displays (such as mounted to the exterior of the housing 26) and might include multiple displays of differing sizes.

While the display devices may comprise one or more video displays, in another embodiment, the gaming machine 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 22 is preferably configured to present one or more games upon a player making a monetary payment or wager. In this regard, as described in more detail below, the gaming machine 22 includes mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 32 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to initiate a reel spin, to “cash out” of the gaming machine, or to provide various other inputs.

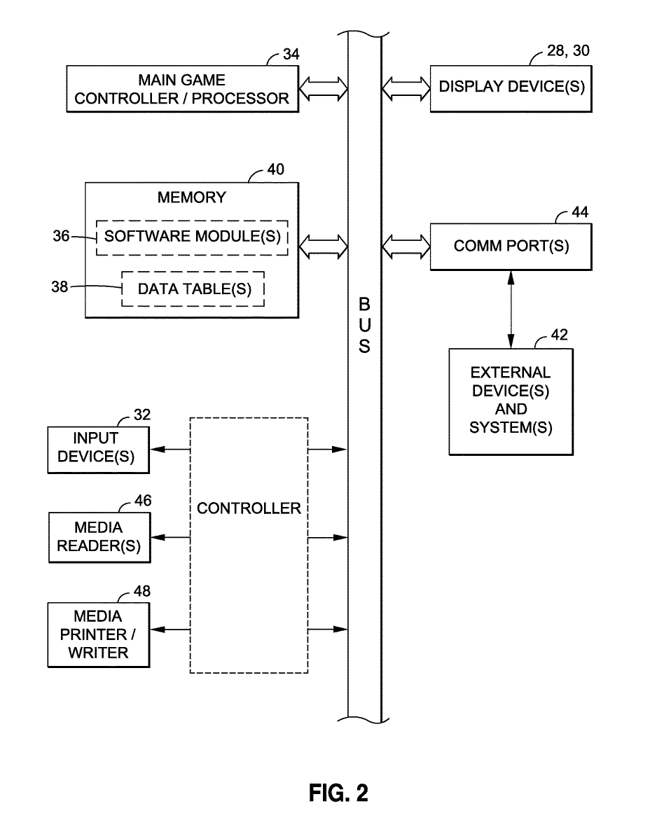

Referring to FIG. 2, in one preferred embodiment, the gaming machine 22 includes at least one microprocessor or controller 34 for controlling the gaming machine, including receiving player input and sending output signals for controlling the various components or peripheral devices of the machine 22 (such as generating game information for display by the display devices 28,30). The controller 34 may be arranged to receive information regarding funds provided by a player to the gaming machine 22, receive input such as a purchase/bet signal when a purchase/bet button is depressed, and receive other inputs from a player. The controller may be arranged to generate information regarding a game, such as generating game information for display by the at least one display device 28,30 (such as information comprising slot game symbols and generated multipliers, as detailed below), for determining winning or losing game outcomes and for displaying information regarding awards for winning game outcomes, among other things.

The controller 34 may be configured to execute machine readable code or “software” or otherwise process information, such as obtained from a remote server. Software 36 or other instructions may be stored at a memory or data storage device 40, e.g. in a fixed or non-transitory configuration. The memory may also store other information or data 40, such as data stored in table or other forms (including, but not limited to look-up tables, pay tables and other information including tracked game play information). The gaming machine 22 may also include one or more random number generators for generating random numbers (such as implemented by a random number generator software module stored in the memory 40 and executable by the processor 34), such as for use in selecting slot symbols, multiplier values and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller 34 is configured to execute machine readable code or instructions (e.g. software) which are configured to implement the game. In this regard, the gaming machine 22 is specially configured to present the game of the invention via specific software and/or hardware which causes the gaming machine to operate uniquely. For example, the controller 34 of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. As indicated above, the machine readable code may be configured in various manners, such as by having various “modules” of software which are designed to implement specific features of the game play or game presentation.

The gaming machine 22 may be configured to generate and present games in a stand-alone manner or it may be in communication with one or more external devices or systems 42 at one or more times. The gaming machine 22 might communicate with one or more of such external devices or systems 42 via one or more communication ports 44 or other interface devices. These ports or interface devices 44 may be configured to implement various communication protocols (including proprietary protocols) and communicate via wireless, wired or other communication link. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, the gaming machine 22 might include a coin acceptor for accepting coins. Of course, associated coin reading/verifying devices and coin storage devices may be associated with the gaming machine 22 if it is configured to accept coins. Likewise, as illustrated in FIGS. 1 and 2, the gaming machine 22 might include a media reader 46. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In this regard, the gaming machine 22 may include one or more media printers or writers 48. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader and/or an associated keypad or other input device (such as a touch screen display). Such player tracking devices are well known and may permit the game operator to track play of players of the gaming machine. The tracked play may be utilized to offer player bonuses or awards.

As illustrated in FIG. 2, the main game controller or processor 34 may communicate with several of the peripheral devices via one or more intermediary controllers. For example, some of the peripheral devices might comprise USB type or enabled devices which are controlled by an intermediary USB controller.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIGS. 1 and 2 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

The gaming machine 22 may, as noted above, be part of a system which includes other devices. For example, the gaming machine 22 may communicate with one or more casino systems, such as a player tracking server or system, an accounting system or server, a ticketing system, a bonusing system, a tournament system, other gaming machines, and external devices.

One embodiment of the invention is a gaming machine and methods of playing and presenting games with accumulating multiplier functionality.

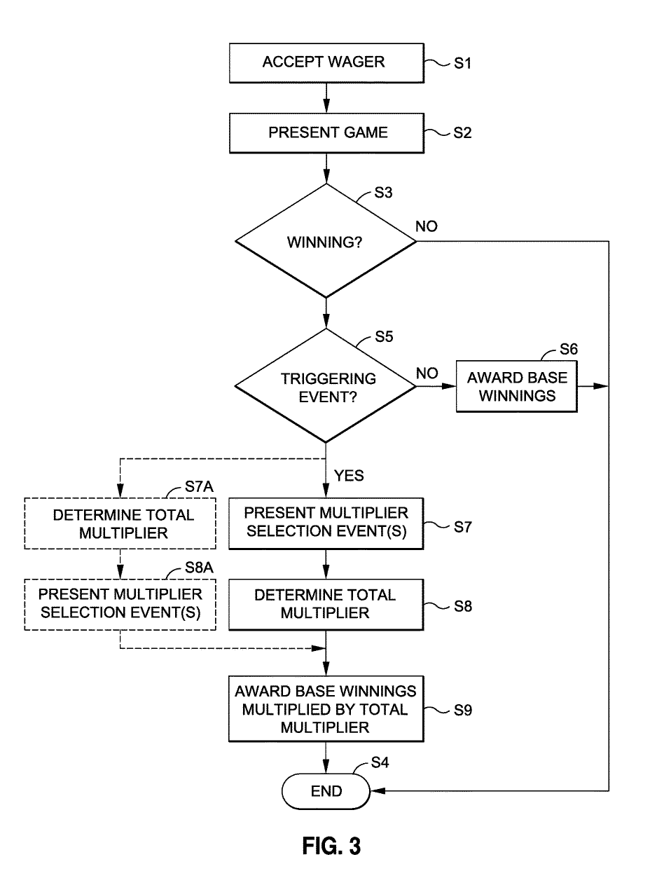

One embodiment of a gaming machine and a method of playing and presenting a game in accordance with an embodiment of the invention will be described with reference to FIG. 3. The game is preferably presented as a wagering game. As such, in a step S1, a wager is accepted from a player. As indicated above, this may comprise a player providing monetary value to the gaming machine in order to associate value with the gaming machine. This value may be represented by one or more credits. In one embodiment, the step of accepting a wager may comprise the player providing a wager input to the gaming machine, such as an input to a “bet one” or “bet max” button, by depressing a spin reels button or the like. As also noted above, when the player places their wager, the credit balance associated with the gaming machine is preferably decreased by the amount wagered.

In a step S2, a base game is presented. This preferably comprises displaying game information to the player, such as via the one or more display devices of the gaming machine. In embodiment, the game information may comprise game outcome information and/or various transitory game information (e.g. starting game information and/or game information between a starting and end set of game information, such as information showing a set of spinning reels and then a stopping position of those reels).

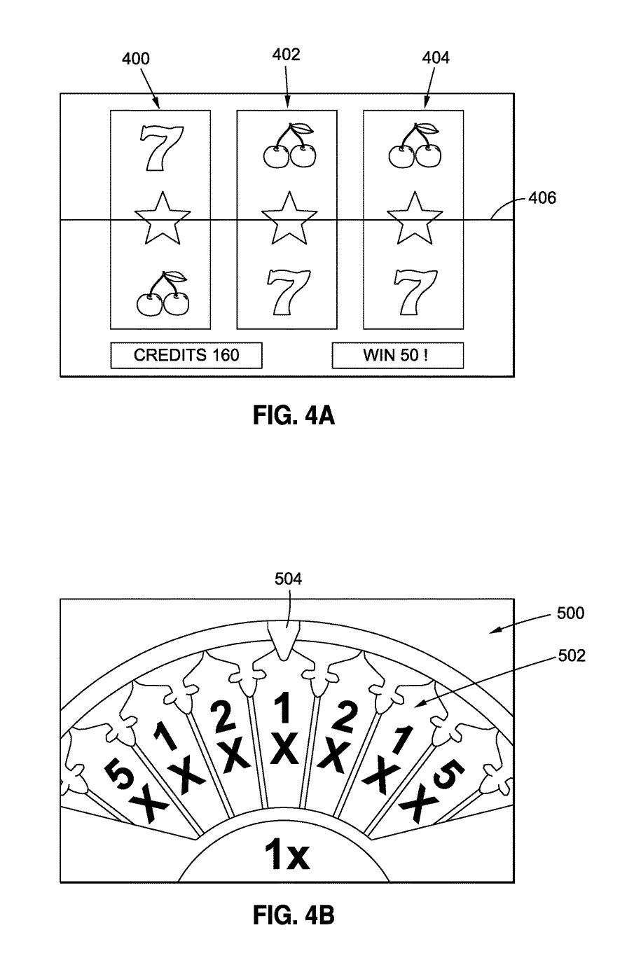

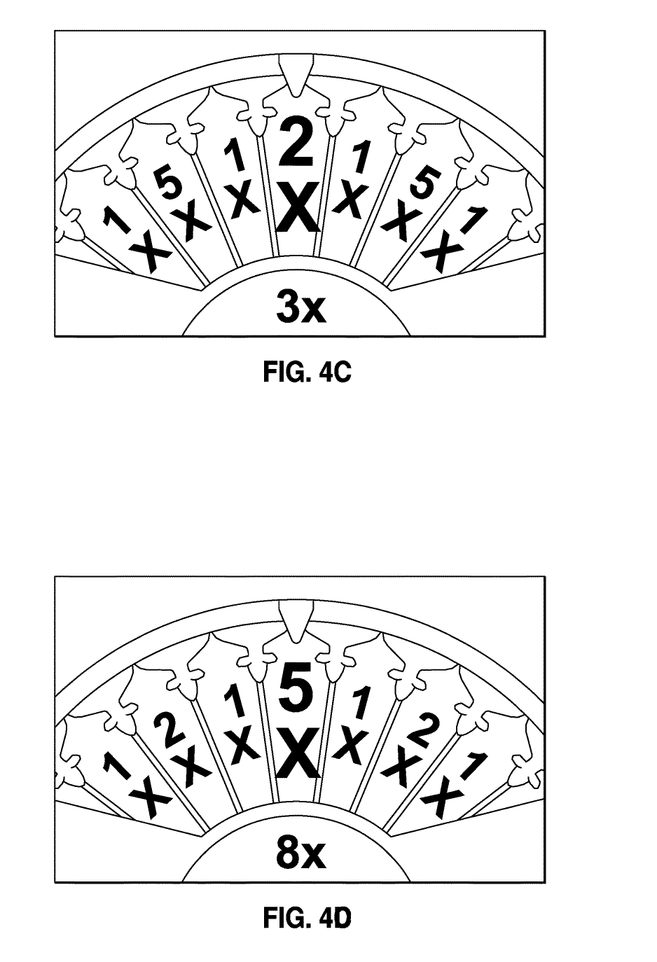

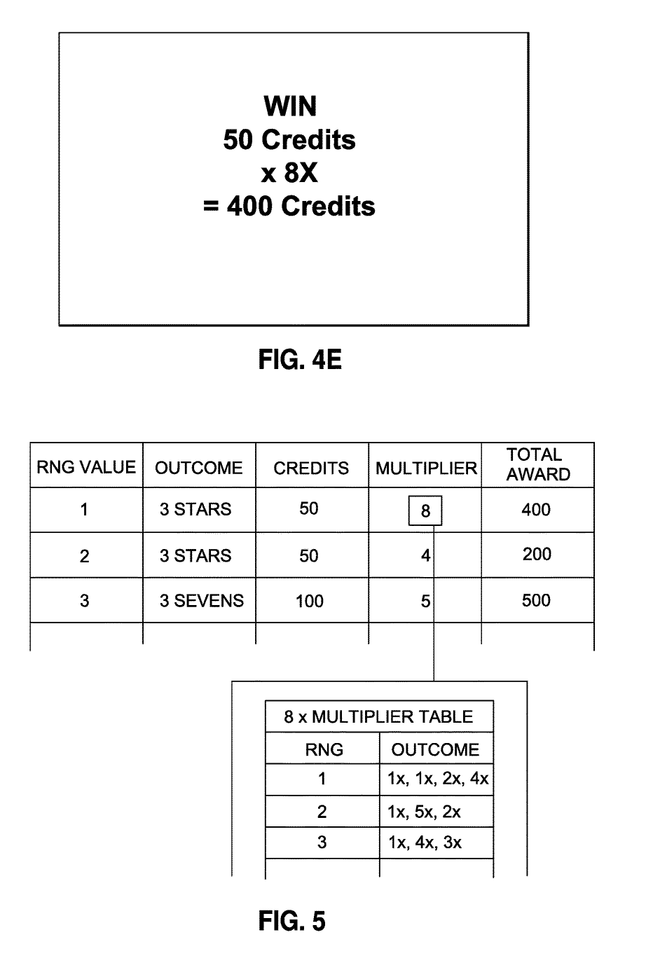

In one embodiment, the base game may comprise a slot-type game in which game symbols are displayed. The game symbols might be displayed by physical rotating reels or by graphical representations thereof displayed by one or more video displays. One example of such a game is illustrated in FIG. 4A. As illustrated, this game comprises a three (3) reel, single pay line slot-type game. In this embodiment, three reels 400, 402, 404 each display a plurality of game symbols (in this case, three (3)). A single pay line 406 is provided relative to the reels. The outcome of the game is defined by the stopping relationship of each reels to the pay line. In this case, each reels 400, 402, 404 has stopped in a position which displays a STAR symbol on the pay line 406.

Of course, the base game might have other configurations, such as other numbers of reels, other numbers of pay lines (or no pay lines, such as where “scatter” wins may be defined). For example, the base game might result in the display of a 4×5 matrix of game symbols with multiple pay lines (which may be linear or non-linear). In addition, the base game might even comprise other than a slot-type game, such as a card game, a dice game, a roulette game or various other games now known or later developed.

Referring again to FIG. 3, in a step S3 it is determined if the outcome of the base game is winning or losing. In one embodiment, the base game has a plurality of different potential outcomes. One or more of those outcomes are defined as winning and the remaining may be defined as losing. The winning outcomes may be defined by a pay table, for example.

Referring to FIG. 4A, in this embodiment, winning outcomes may be defined as certain combinations of symbols which are defined along the pay line 406. For example, three (3) STAR symbols along the pay line 406 may be defined as a winning outcome. Of course, various outcomes might be defined as winning, such as various combination of symbols along one or more paylines, a “scatter” outcome of certain symbols displayed anywhere or the like. Of course, other outcomes may be defined as winning relative to other types of games (e.g. certain combinations of cards in a video poker game, certain die combinations in a dice game, etc.)

If in step S3 the outcome of the base game is losing, then in a step S4, the game may end.

If in step S3 the outcome of the game is winning, then in a step S5, it is determined if a triggering event has occurred. In one embodiment, the triggering event may comprise one or more particular game symbols or symbols combinations, such as one or more winning outcomes. For example, referring to the example game illustrated in FIG. 4A, a triggering event may comprise any combination of three (3) of the same game symbols along the pay line 406. Of course, other triggering events might be defined, such as depending upon the base game. In some cases, the triggering event could be randomly determined or be based upon external criteria or events, such as amounts wagered or the like. In another embodiment, it is possible for the triggering event to occur every game (in such a configuration one or more multiplier value presentation events would always be displayed, as described below).

If in step S5 no triggering event has occurred, then in step S6 winnings are awarded for the winning outcome of the base game. In one embodiment, a pay table may defined winning outcomes and associated winnings. For example, the winnings or award may comprise one or more credits. The credits may be added to the player's credit balance at the gaming machine. Thereafter, the game may end, as in step S4.

If in step S5 a triggering event has occurred, then in step S7 at least one multiplier value presentation or selection event is presented. In a preferred embodiment, the multiplier presentation or selection events result in or define an accumulated or total multiplier value.

One example of this functionality will be described with reference to FIGS. 4B-4D. As illustrated in FIG. 4B, a first multiplier value selection or presentation event may be displayed to the player. In this example, the multiplier value selection or presentation event comprises displaying a starting or base multiplier value of 1× along with the graphical representation of a rotating wheel.

One or more additional multiplier value presentation or selection events are then displayed. In the example illustrated in FIG. 4C, a wheel 500 which displays a plurality of multiplier values 502 is rotated (virtually) relative to a pointer 504. However, the presentation or selection event could comprise the rotation of a physical wheel or other display events (such as, but not limited to player selection of boxes that reveal multiplier values, balloons popping to reveal multiplier values, multiplier values might simply be displayed in sequence rather than “selected” via a rotating wheel, etc.). In the example illustrated in FIG. 4C, a multiplier wheel spin is displayed. In this example, the result of the wheel spin is the selection of a 2× multiplier. As illustrated in FIG. 4D, yet another multiplier wheel spin is displayed. In this example, the result of the wheel spin is the selection of a 5× multiplier.

In accordance with the present invention, multiple multiplier presentation or selection events are displayed to generate an accumulated or total multiplier value, as in a step S8. In the example illustrated in FIGS. 4B-4D, the player received the base or starting 1× multiplier, a 2× multiplier and a 5× multiplier, for an accumulated or “summed” multiplier value of 8× (1+2+5=8).

Of course, any number of events may be used to display or select the multiplier values and they may be displayed in sequence or at the same time (for example, four wheels might be displayed and rotated at the same time). For example, a player might receive only two (2) multiplier value presentation or selection events or might receive three (3), four (4) or more of such events. Regardless of how the multiplier values are shown or selected, an aspect of invention comprises the accumulation of multiplier values.

In addition, the multiplier presentation or selection events may be displayed in succession (such as described above) or might be displayed at the same time (overlapping in time or substantially simultaneously). For example, in one embodiment, two or more multiplier wheels might be displayed (the wheels might be the same or have differing numbers of segments and/or multiplier values or other characteristics) and the wheels might be spun at the same time. The outcome of the spins of those two wheels may comprise multiplier values which define or comprise the total accumulated multiplier value. In one preferred embodiment, three multiplier wheels may be displayed and rotated/spun at the same time to define three multiplier values which are aggregated (with or without a starting multiplier value to which the wheel spin multiplier values are added).

As indicated above, the multiplier value might have a starting value and the wheel spin(s) or other presentation or selection events might result in multiplier values which are added to that starting value. For example, in one embodiment, the multiplier value may start at 1×. Then additional multipliers which are selected or displayed are added to that base value. For example, if the base multiplier value of 1× is utilized and then a first wheel spin results in the display or selection of a multiplier value of 2×, the total multiplier would be 3×. Of course, the multiplier value might start at other values. For example, the base multiplier value might comprise 10× and then one or more multiplier display or selection events might display additional multiplier values which are added to that value.

In other embodiments, no starting multiplier value may be used and instead a number of selection events may simply be presented in succession to the player.

In one embodiment, it is possible for the multiplier values to accumulate via multiplication thereof rather than a summation thereof. For example, if a player received a first 2× multiplier value and a second 3× multiplier value, the player might receive a total multiplier value of 6×.

In a step S9, a total award is determined. This award comprises the base winnings (associated with the base game winning outcome) multiplied by the total multiplier. For example, as illustrated in FIG. 4A, the base game outcome may comprise a winning outcome having an associated award of 50 credits. In the case where the total multiplier value is 8× as illustrated in FIG. 4D, the total award would be 50 credits ×8, or 400 credits, as illustrated in FIG. 4E.

Again, the total award may be awarded to the player in the form of credits associated with the player's credit balance at the gaming machine (which the player may then wager, cash-out or the like).

The base game and accumulating multiplier functionality may be implemented in various manners. In one embodiment, a game outcome is determined using a random number generator. For example, the memory of the gaming machine may store a data or look-up table of game outcomes indexed to selected random numbers, such as illustrated in FIG. 5. As one example, the controller may compare a generated random number to a first lookup table. That random number might index to the three (3) STARS outcome (having a base award of 50 credits) and an 8× multiplier, for a total award of 400 credits (in this configuration, the steps of determining whether the base game outcome is winning, whether a triggering event has occurred, and the total multiplier value are determined as part of the selection of the overall outcome). The controller may then compare another generated random number to a second lookup table where the multiplier associated with the selected award is indexed to one or more presentation event options which result in that multiplier (for example, relative to the described 8× multiplier, these options might comprise or include one option where there is a starting multiplier value of 1× and three wheel spins are displayed having the values 1×, 2× and 4× (such that the starting value of 1× plus the wheel spin multipliers of 1×, 2× and 4× totals 8×), and two others where a starting 1× value is used and two wheel spins are displayed having the values 5× and 2× or 4× and 3×). The base game outcome and multiplier presentation events associated with the selected multiplier presentation option are then displayed, such as in FIGS. 4A-4D where a reel spin which results in the selected three (3) STARS outcome is displayed, and then the multiplier wheel selection events are displayed which result in a total accumulated multiplier of 8× (and thus the total award of 400 credits).

Of course, other mechanisms may be utilized to generate the game data. For example, in one embodiment, a lookup table based upon the total multiplier might not contain every possible combination of wheel stops to arrive at a given multiplier. For example, a total multiplier of 25× could be represented as 24 spins which each result in the selection of a 1× multiplier (which added to a starting multiplier value of 1× would total 25×), but such a presentation may not be included in the table because it is undesirable from a presentation perspective. Also, as noted above, the lookup table may be weighted to allow some favored combinations to appear more often.

It is noted that in the configuration just described, the total multiplier value is technically determined or selected before the selection or display events are presented. Such a configuration is shown in FIG. 3 wherein after a triggering event, in a step S7A, the total multiplier is determined and then in a step S8A, the multiplier selection or display events are presented. In this regard, various of the steps which are illustrated and described herein may be performed in various orders.

While one aspect of the invention is a game in which multiple multiplier selection or presentation events are displayed, the game may include the display of a single multiplier value presentation or selection event at one or more times. For example, a first game outcome might comprise a particular winning outcome having a base award of 100 credits and a 2× multiplier which is selected in a single wheel spin, for a total award of 200 credits. A next game outcome might comprise a particular winning outcome having a base award of 25 credits and a 4× multiplier which is generated by two wheel spins each having a 2× outcome, thus resulting in a total award of 100 credits. Thus, the accumulating multiplier feature might not always be utilized, but is preferably utilized or presented at one or more times.

While the games and gaming machines described herein may be configured to present wagering games, the games may be presented in other formats. For example, the game herein might be presented as an amusement game in which monetary value awards such as credits are now awarded. Instead, points or the like might be awarded (wherein points for designated winning outcomes are multiplied by a total accumulated multiplier value). Those points might not have any direct monetary value. In some cases, the points might be redeemed for prizes or the like, or might simply represent an outcome of the game.

The game and gaming machine are uniquely configured with accumulating multiplier functionality. This functionality is preferably implemented by a unique configuration of lookup tables or similar information and is presented to a player via the presentation of uniquely generated graphical information.

An important aspect of the functionality of the invention is that it result in an exciting presentation of game information (base game outcome and multiple multiplier presentation events to generate an accumulated multiplier value). As one aspect of the invention, anticipation regarding the outcome of the game is generated as the player watches the presentation of a sequence of multiplier presentation events to reveal the total multiplier value which is applied to their base win.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a monetary funds accepting mechanism for accepting monetary funds in creating a player credit balance;
at least one display device;
at least one player input device;
a memory device;
a controller; and
machine-readable code stored in said memory device executable by said controller to, in response to a wager placed by said player from said player credit balance, cause said at least one display device to present a base game comprising the display of a plurality of game symbols via said at least one display device;
machine-readable code executable by said controller to cause said controller to present a plurality of multiplier value presentation events via said at least one display device, each multiplier value presentation event comprising the display of a selected multiplier value, said selected multiplier values associated with said plurality of multiplier value presentation events comprising a total multiplier value; and
machine-readable code executable by said controller to cause said controller to award an award to said player for a winning outcome of said base game, said award having a value comprising a base award value for said winning outcome multiplied by said total multiplier value, said award being credits to said player credit balance.

2. The gaming machine in accordance with claim 1 wherein said multiplier value presentation events comprise display of a starting multiplier value and at least one wheel spin which displays an additional multiplier value.

3. The gaming machine in accordance with claim 1 wherein one or more of said multiplier value presentation events comprise the display of a plurality of spins of at least one multiplier wheel, said multiplier wheel having a plurality of segments, at least two of said segments displaying different multiplier values.

4. The gaming machine in accordance with claim 1 wherein said plurality of multiplier value presentation events comprise the simultaneous display of a plurality of multiplier value wheels.

5. The gaming machine in accordance with claim 1 wherein said base game comprises a slot type game in which one or more of said plurality of game symbols are displayed relative to at least one pay line.

6. The gaming machine in accordance with claim 1 wherein said machine-readable code is configured to cause said controller to select a base game outcome from a set of possible base game outcomes from at least one first table.

7. The gaming machine in accordance with claim 6 wherein at least one of said base game outcomes comprises a winning outcome having said award defined by said total multiplier value.

8. The gaming machine in accordance with claim 7 further comprising machine-readable code configured to cause said controller to select a configuration of presentation events corresponding to said total multiplier value from at least one second table.

9. The gaming machine in accordance with claim 8 wherein at least one second table defines at least two different configurations of two or more presentation events which result in the display of multiplier values which when summed equal said total multiplier value.

10. The gaming machine in accordance with claim 1 wherein said machine-readable code is configured to only cause said controller to present said plurality of multiplier value presentation events if an outcome of said base game is at least one designated winning outcome.

11. A method of presenting a game at a gaming machine comprising the steps of:
receiving a physical item associated with a monetary value at a wager accepting device of the electronic gaming device to increase a credit balance stored on the electronic gaming device;
receiving a wager on a base game via an input device of the electronic gaming device;
initiating the base game via one or more processors;
displaying, via at least one display device, a plurality of game symbols via said at least one display device;
presenting a plurality of multiplier value presentation events via said at least one display device, each of said multiplier value presentation events comprising the display of a selected multiplier value, said selected multiplier values associated with said plurality of multiplier value presentation events comprising a total multiplier value; and
awarding an award to said player for a winning outcome of said base game, said award having a value comprising a base award value for said winning outcome multiplied by said total multiplier value, said award being credits to said player credit balance.

12. The method in accordance with claim 11 wherein said multiplier value presentation events comprise the display of a base multiplier value and at least one wheel spin which displays an additional multiplier value.

13. The method in accordance with claim 11 wherein one or more of said multiplier value presentation events comprise the display of a plurality of spins of at least one multiplier wheel, said multiplier wheel having a plurality of segments, at least two of said segments displaying different multiplier values.

14. The method in accordance with claim 11 wherein said plurality of multiplier value presentation events comprise the simultaneous display of a plurality of multiplier value wheels.

15. The method in accordance with claim 11 wherein said base game comprises a slot type game in which one or more of said plurality of game symbols are displayed relative to at least one payline.

16. The method in accordance with claim 11 wherein said step of initiating said base game comprises selecting a base game outcome from a set of possible base game outcomes from at least one first table.

17. The method in accordance with claim 16 wherein at least one of said base game outcomes comprises a winning outcome having said award defined by said total multiplier value.

18. The method in accordance with claim 17 further comprising selecting a configuration of presentation events corresponding to said total multiplier value from at least one second table.

19. The method in accordance with claim 18 wherein at least one second table defines at least two different configurations of two or more presentation events which result in the display of multiplier values which when summed equal said total multiplier value.

20. The method in accordance with claim 11 comprising only presenting said plurality of multiplier value presentation events if an outcome of said base game is at least one designated winning outcome.
